(19) United States
(12) Patent Application Publication
(10) Pub. No.: US 2020/0033683 A1
(43) Pub. Date: Jan. 30, 2020

(54) ARRAY SUBSTRATE FOR LIQUID CRYSTAL DISPLAY DEVICE, AND LIQUID CRYSTAL DISPLAY DEVICE

(71) Applicant: SHARP KABUSHIKI KAISHA, Caki City (TW)

(72) Inventor: TAKUYA NOMURA, Sakai City (JP)

(21) Appl. No.: 16/509,907

(22) Filed: Jul. 12, 2019

Related U.S. Application Data
(60) Provisional application No. 62/703,160, filed on Jul. 25, 2018.

(51) Int. Cl. G02F 1/1362

(52) U.S. Cl. CPC G02F 1/136277; G02F 1/136286; G02F 1/136209

(57) ABSTRACT

The present invention provides an array substrate for a liquid crystal display device capable of reducing occurrence of SiN film peeling on a transparent conductive film, and a liquid crystal display device. The array substrate for a liquid crystal display device of the present invention includes a transparent conductive film, film pieces on the transparent conductive film, and a silicon nitride film disposed on the transparent conductive film and the film pieces and covering the film pieces. The film pieces are apart from each other.

### CROSS-REFERENCE TO RELATED APPLICATIONS

The present application claims priority under 35 U.S.C. § 119 to U.S. Provisional Patent Application No. 62/703,160 filed on Jul. 25, 2018, the contents of which are incorporated herein by reference in their entirety.

### BACKGROUND OF THE INVENTION

### Field of the Invention

The present invention relates to array substrates for liquid crystal display devices, and liquid crystal display devices. The present invention specifically relates to an array substrate for a liquid crystal display device including a silicon nitride film on a transparent conductive film, and a liquid crystal display device.

### Description of Related Art

Liquid crystal display devices have a structure including an array substrate for a liquid crystal display device (hereinafter, also referred to simply as an array substrate). The array substrate includes pixel regions constituting pixels of a liquid crystal display device.

The array substrate includes a stack of various components such as lines, semiconductor elements, electrodes, and insulating films, on an insulating substrate. A known example of the array substrate is a thin film transistor (hereinafter, also abbreviated as a TFT) array substrate including a TFT that serves as a semiconductor element in each pixel region.

For example, JP 2015-122449 A discloses a method for producing a substrate device including an insulating film layer provided on a substrate, an oxide conductive film provided on portions of the insulating film layer, and a silicon nitride film provided on the oxide conductive film.

### BRIEF SUMMARY OF THE INVENTION

FIG. 16 is a photograph showing peeling of a silicon nitride film on an indium tin oxide film. Some array substrates such as TFT array substrates include a transparent conductive film that serves as a transparent electrode. This transparent electrode may be an indium tin oxide film (hereinafter, also referred to as an ITO film) that serves as an oxide conductive film, and a silicon nitride film (hereinafter, also referred to as a SiN film) that serves as an insulating film may be disposed thereon. Still, as in the region surrounded by the dashed line in FIG. 16, the SiN film and the ITO film are less closely bonded to each other, and the SiN film may easily be peeled and removed from the ITO film, resulting in reliability failure. Specifically, when such an array substrate is used in an FFS-mode liquid crystal display device, the ITO film is used as a counter electrode, and a pixel electrode is disposed on the SiN film so as to face the ITO film, the SiN film on the ITO film may rise and the pixel electrode may be electrically separated from the counter electrode, so that the pixel in question may fail to provide intended charge and discharge. This may cause reliability failure, i.e., what is called dark defect on a white screen, in aging evaluation in a high-temperature high-humidity environment. The mechanism of occurrence of such SiN film peeling is not clarified. Still, it seems to be that adhesion of an organic residue on the outermost surface of the ITO film and appearance of indium or tin on part of the outermost surface due to oxygen deficiency or reduction of the ITO film way lead to weak bonding of the ITO film and the SiN film, resulting in poor adhesion.

It should be noted that JP 2015-122449 A discloses, for the purpose of preventing SiN film peeling on the ITO film, a technique of reducing peeling by performing plasma discharging as a surface treatment before SiN film formation to clean the ITO film surface and improve the adhesion, and then etching the insulating film not covered with the ITO film to lead the SiN film under the ITO film.

Nevertheless, in the case of a SiN film having a high membrane stress, adhesion improvement by cleaning of the ITO film surface alone may be insufficient for prevention of peeling. Some ITO film patterns have a small opening area and thus have difficulty in leading the SiN film under the ITO film, which may also be insufficient for prevention of peeling.

The same issue may occur when a transparent conductive film other than the ITO film is used.

The present invention is made in view of the above current state of the art, and aims to provide an array substrate for a liquid crystal display device capable of reducing occurrence of SiN film peeling on a transparent conductive film, and a liquid crystal display device.

(1) An embodiment of the present invention relates to an array substrate for a liquid crystal display device, the array substrate including: a transparent conductive film; film pieces on the transparent conductive film; and a silicon nitride film disposed on the transparent conductive film and the film pieces and covering the film pieces, the film pieces being apart from each other.

(2) In an embodiment of the present invention, the array substrate for a liquid crystal display device has the above structure (1) and the film pieces are arranged in a dashed line pattern.

(3) In an embodiment, of the present invention, the array substrate for a liquid crystal display device has the above structure (1) and the film pieces are arranged in an island pattern.

(4) In an embodiment of the present invention, the array substrate for a liquid crystal display device has the above structure (1), (2), or (3) and further includes: a thin film transistor; a source line coupled with the thin film transistor; and a gate line coupled with the thin film transistor and crossing the source line, wherein, in a plan view, the film pieces are each in a region including at least one of the source line or the gate line.

(5) Another embodiment of the present invention relates to a liquid crystal display device including the array substrate for a liquid crystal display device having the above structure (1), (2), (3), or (4).

(6) In an embodiment of the present invention, the liquid crystal display device has the above structure (5) and further includes a counter substrate facing the array substrate for a liquid crystal display device, and pixels arranged in a matrix pattern, wherein the counter substrate includes a light-shielding member between adjacent pixels, and in a plan view, the film pieces are each in a region including the light-shielding member.

The present invention can provide an array substrate for a liquid crystal, display device capable of reducing occurrence of SiN film peeling on a transparent conductive film, and a liquid crystal display device.

### BRIEF DESCRIPTION OF THE DRAWINGS

FIG. 1 is a schematic plan view of a liquid crystal display device of Embodiment 1.

FIG. 2 is a schematic cross-sectional view of the liquid crystal display device of Embodiment 1.

FIG. 3 is a schematic cross-sectional view of the liquid crystal display device of Embodiment 1.

FIG. 4 is an exemplary schematic cross-sectional view of a region around a TFT of an array substrate in the liquid crystal display device of Embodiment 1.

FIG. 5 includes schematic cross-sectional views for comparison of the liquid crystal display device of Embodiment 1 and a liquid crystal display device of Comparative Embodiment 1.

FIG. 6 includes schematic cross-sectional views for comparison of the liquid crystal display device of Embodiment 1 and the liquid crystal display device of Comparative Embodiment 1.

FIG. 7 is a schematic plan view of a liquid crystal display device of Embodiment 2.

FIG. 8 is a schematic cross-sectional view of the liquid crystal display device of Embodiment 2.

FIG. 9 is a schematic cross-sectional view of the liquid crystal display device of Embodiment 2.

FIG. 10 includes schematic cross-sectional views for comparison of the liquid crystal display device of Embodiment 2 and the liquid crystal display device of Comparative Embodiment 1.

FIG. 11 includes schematic cross-sectional views for comparison of the liquid crystal display device of Embodiment 2 and the liquid crystal display device of Comparative Embodiment 1.

FIG. 12 is a schematic plan view of a liquid crystal display device of Embodiment 3.

FIG. 13 is a schematic cross-sectional view of the liquid crystal display device of Embodiment 3.

FIG. 14 is a schematic cross-sectional view of the liquid crystal display device of Embodiment 3.

FIG. 15 includes schematic cross-sectional views for comparison of the liquid crystal display device of Embodiment 3 and the liquid crystal display device of Comparative Embodiment 1.

FIG. 16 is a photograph showing peeling of a silicon nitride film on an indium tin oxide film.

### DETAILED DESCRIPTION OF THE INVENTION

The following describes the array substrate for a liquid crystal display device and the liquid crystal display device according to embodiments of the present invention. The following embodiments are not intended to limit the scope of the present invention. The design thereof may be modified as appropriate within the scope satisfying the structure of the present invention. Any features of the embodiments may be combined or modified as appropriate within the spirit of the present invention.

The array substrate for a liquid crystal display device (hereinafter, array substrate) according to an embodiment of the present invention includes a transparent conductive film, film pieces on the transparent conductive film, and a silicon nitride film (hereinafter, SiN film) disposed on the transparent conductive film and the film pieces and covering the film pieces, the film pieces being apart from each other.

The presence of a transparent conductive film and a SiN film on the transparent conductive film in the array substrate may cause a concern for SiN film peeling from the transparent conductive film, as described above. On the contrary, the array substrate further includes film pieces on the transparent conductive film and a SiN film is disposed on the film pieces and covers the film pieces, so that the film pieces can generate an anchoring effect. The film pieces apart from each other can increase the contact area of tapered portions of the film pieces and the SiN film, improving the anchoring effect. The presence of the film pieces on the transparent conductive film can also reduce the contact area between the SiN film and the transparent conductive film with poor adhesion. This can reduce occurrence of SiN film peeling on the transparent conductive film, resulting in improved reliability of the array substrate.

The transparent conductive film is preferably an oxide conductive film. Examples of a suitable material of the transparent conductive film include transparent conductive materials such as indium tin oxide (ITO), indium zinc oxide (IZO), indium gallium zinc oxide (In—Ga—Zn—O), zinc oxide (ZnO), and tin oxide (SnO), and alloys of any of these.

The transparent conductive film may include a single layer formed from a single material, or may include a stack of layers in which two adjacent layers among the layers are formed from different materials.

The transparent conductive film may be formed in a single layer or multiple layers by sputtering. The transparent conductive film formed may be patterned by photolithography or wet etching.

The film pieces may be formed from any material, such as a metal (metal film), a metal compound (metal compound film), or an organic compound (organic film). The metal is preferably a metal resistant to electrolytic corrosion, more preferably molybdenum (Mo) or titanium (Ti). The metal compound is preferably a metal nitride, more preferably molybdenum nitride (MoN) or titanium nitride (TiN). The organic compound is preferably polyimide (PI). Such an embodiment can improve the adhesion of the SiN film and the film pieces and the adhesion of the transparent conductive film and the film pieces in comparison with the adhesion of the transparent conductive film and the SiN film. This can more effectively reduce occurrence of SiN film peeling on the transparent conductive film.

The film pieces may be of a single layer formed from the same material, or may be of a stack of layers in which any two adjacent layers among the layers are formed from different materials.

The film pieces formed from at least one of a metal or a metal compound are preferably formed by sputtering. Such an embodiment can improve the adhesion of the film pieces and the transparent conductive film in comparison with film pieces formed by vapor deposition or chemical vapor deposition (CVD). The film pieces may be formed by preparing a mono-layer or multi-layer film by sputtering, and then patterning the film by photolithography and wet or dry etching.

The film pieces formed from an organic compound may be formed as follows. Specifically, an organic film material that is a photoresist is applied by spin coating, for example, and then the photoresist is exposed through a photomask and developed, so that the photoresist is patterned.

The SiN film is a film containing silicon nitride (SiNx), and can be formed by CVD. The SiN film formed may be patterned by photolithography and dry etching.

Each film piece preferably has a convex set shape. A film piece and the transparent conductive film show a slightly reduced adhesion at a portion with a relatively large contact area. For example, in the case of the film pieces arranged in a mesh pattern (grid pattern) on the transparent conductive film, the film pieces at intersections may possibly be peeled. This is presumably because a stress concentration occurs at a portion with a relatively large contact area. Thus, in the present embodiment, each film piece preferably has a convex set shape. Such an embodiment can alleviate the stress concentration on each film piece, more effectively reducing occurrence of SiN film peeling on the transparent conductive film.

Examples of the convex set shape include a circle, an ellipse, convex polygons (e.g., square, rectangle), a shape that has at least one symmetry axis and is similar to an ellipse (e.g., oval), and a shape that is a combination of at least two of these.

The film pieces may be arranged in a dashed line pattern. Such an embodiment can alleviate the stress concentration on the film pieces, more effectively reducing occurrence of SiN film peeling on the transparent conductive film. In this embodiment, the film pieces form a directional pattern, and usually enables perception of only a single line (dashed line) constituted by the film pieces. Examples of the line include a straight line, a curved line, a line that is a combination of straight lines, a line that is a combination of curved lines, and a line that is a combination of one or more straight lines and one or more curved lines. Specific examples of such an embodiment include an embodiment in which the film pieces are periodically placed on a source line and an embodiment in which the film pieces are periodically placed on a gate line. The film pieces arranged in a dashed line pattern each may have either a linear shape (e.g., rectangle) or a dot shape (e.g., circle or square). Embodiments in which the film pieces are arranged in a dotted line pattern, a dot-dash line pattern, or a two-dot chain line pattern are also encompassed by the embodiment in which the film pieces are arranged in a dashed line pattern.

The film pieces may be arranged in an island pattern. Such an embodiment can alleviate the stress concentration on the film pieces, more effectively reducing occurrence of SiN film peeling on the transparent conductive film. In this embodiment, the film pieces form a non-directional pattern, and usually enables perception of no specific line (dashed line) constituted by the film pieces or perception of two or more lines (dashed lines) constituted by the film pieces, for example of an embodiment in which no specific line (dashed line) can be perceived is an embodiment in which the film pieces are randomly arranged. An example of an embodiment, in which two or more lines (dashed lines) can be perceived is an embodiment in which the dot-shaped film pieces are arranged at the respective intersections of a square grid or rectangular grid. This is because the presence of the dot-shaped film pieces at the respective intersections of such a grid enables perception of dashed lines vertically and horizontally (and obliquely, in some cases). An example of such an embodiment is an embodiment, in which dot-shaped film pieces are arranged at the respective intersections of the source lines and the gate lines. The film, pieces arranged in an island pattern each may have either a dot shape (e.g., circle or square) or a linear shape (e.g., rectangle).

Preferably, the array substrate further includes a thin film transistor (hereinafter, TFT), a source line coupled with the TFT, and a gate line coupled with the TFT and crossing the source line, and in a plan view, the film pieces are each in a region including at least one of the source line or the gate line. This can reduce occurrence of SiN film peeling on the transparent conductive film without reducing the transmittance of each pixel region. This also enables arrangement of the film pieces in any of various patterns even though the TFT design is limited (e.g., in the case where the line width is narrow and the film pieces are less easily arranged).

The “pixel region” means a region corresponding to a pixel or a subpixel of the liquid crystal display device and serves as a light-transmitting region (opening region) that transmits light. The “gate line” means a line coupled with a gate electrode of the TFT (usually a bus line coupled with multiple gate electrodes), and emits a scanning signal (a signal for controlling the on- and off-state of the TFT) to the gate electrode of the TFT coupled therewith. The “data line” means a line coupled with a source electrode of the TFT (usually a bus line coupled with multiple source electrodes), and emits a data signal (image signal) to the TFT coupled therewith.

The film pieces are usually in an array region Including the TFTs arranged in a matrix pattern, and may not be extended to a peripheral region around the array region. The pixel regions each may be provided with at least one film piece. The film pieces each may have a maximum length that is shorter than the pitch of the pixel region, i.e., the pixel pitch in the liquid crystal display device. The film pieces may be regularly arranged at a predetermined pitch which, may be equal to or shorter than the pitch of the pixel region (pixel pitch).

The liquid crystal display device according to an embodiment of the present invention includes the aforementioned array substrate. This can improve the reliability of the liquid crystal display device. Specifically, for example, an FFS-mode liquid crystal display device including a counter electrode that is a transparent conductive film and a pixel electrode disposed on the SiN film and facing the transparent conductive film can reduce a rise of the SiN film on the transparent conductive film. This enables intended charge and discharge between the transparent conductive film and the pixel electrode, reducing reliability failure, what is called dark defect.

Preferably, the liquid crystal display device includes a counter substrate facing the array substrate and pixels arranged in a matrix pattern, the counter substrate includes a light-shielding member between pixels adjacent to each other, and in a plan view, the film pieces are in a region including the light-shielding member. This can effectively reduce a decrease in contrast ratio due to light reflected on the surfaces of the film pieces. If the film pieces are not shielded from light, light such as external light may reflect on the surfaces of the film pieces and the contrast ratio may decrease.

The liquid crystal display device may be either a gray-scale liquid crystal display device or a color liquid crystal display device. In the case of a color liquid crystal display device, the pixel may be a subpixel. The “pixel” means a display unit constituting an image displayed on the liquid crystal, display device. The “subpixel”, also sub-pixel, means a region of a single color (usually, a primary color) included in a pixel constituting a color image.

The light-shielding member is preferably a resin black matrix layer that is a black matrix layer formed from a black resin material.

Array substrates for liquid crystal display devices and liquid crystal display devices according to other embodiments of the present invention are described in more detail below with reference to the drawings. In the following, the same components or the components having the same or similar functions are provided with the same reference sign in the drawings, and description of such components is not repeated.

### Embodiment 1

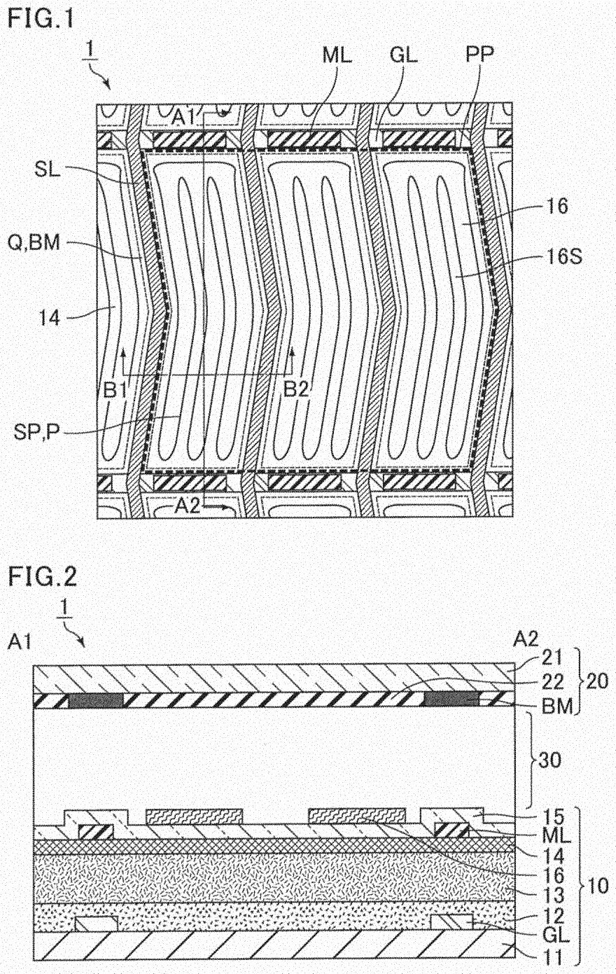

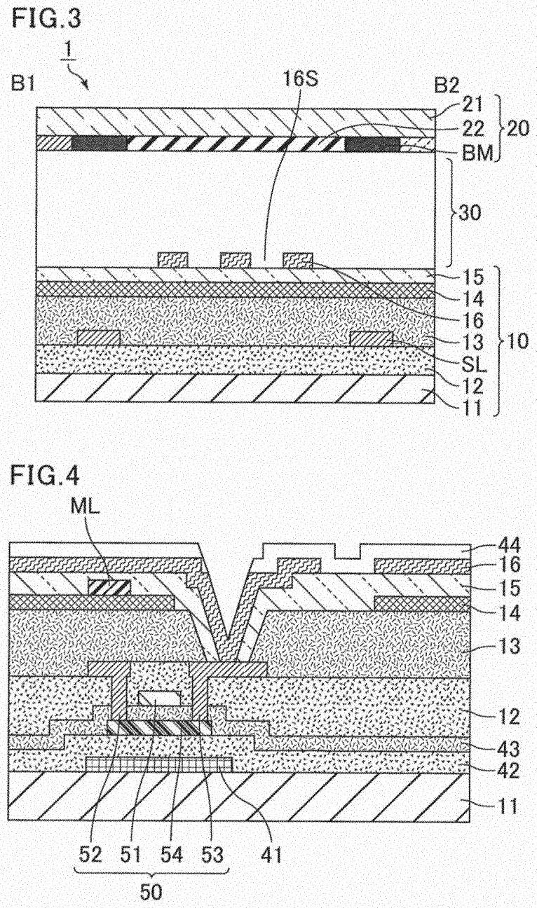

FIG. 1 is a schematic plan view of a liquid crystal display device of Embodiment 1, illustrating part of the structure of a display region. FIG. 2 is a schematic cross-sectional view of the liquid crystal display device of Embodiment 1, illustrating the cross section taken along the A1-A2 line in FIG. 1. FIG. 3 is a schematic cross-sectional view of the liquid crystal display device of Embodiment 1, illustrating the cross section taken along the B1-B2 line in FIG. 1. As illustrated in FIG. 1, a liquid crystal display device 1 of the present embodiment includes a display region in which pixels PP each composed of subpixels SP of multiple respective colors (e.g., red, green, blue) are arranged in a matrix pattern, and displays an image in the display region by driving the subpixels SP. As illustrated in FIGS. 2 and 3, the liquid crystal display device 1 includes an array substrate 10 for a liquid crystal display device (hereinafter, an array substrate 10), a counter substrate 20 facing the array substrate 10, a liquid crystal layer 30 between the array substrate 10 and the counter substrate 20, and a backlight (not illustrated) behind (on the back side of) the array substrate 10. The display region of the liquid crystal display device 1 corresponds to the array region of the array substrate 10.

As illustrated in FIG. 1, the array substrate 10 includes source lines SL parallel to each ether, gate lines GL parallel to each other and crossing the source lines SL, TFTs (not illustrated in FIG. 1) serving as switching elements, pixel regions P corresponding to the subpixels SP, and pixel electrodes 16 disposed in each pixel region P and provided with slits 16S. Each pixel region P is disposed in a region surrounded by two source lines SL adjacent to each other and two gate lines GL adjacent to each other. Each TFT is coupled with a corresponding source line SL among the source lines SL and with a corresponding gate line GL among the gate lines GL, and is a three-terminal switch including a gate electrode coupled with the corresponding gate line GL, a source electrode coupled with the corresponding source line SL, a drain electrode coupled with the corresponding pixel electrode 16 among the pixel electrodes 16, and a thin film semiconductor. The pixel electrode 16 is coupled with a source line SL via a thin film semiconductor.

As illustrated in FIGS. 2 and 3, the array substrate 10 includes an insulating substrate 11, gate lines GL on the insulating substrate 11, an interlayer insulating film 12 covering the gate lines GL, source lines SL on the interlayer insulating film 12, an organic insulating film 13 covering the source lines SL, an indium tin oxide film (hereinafter, ITO film) 14 serving as a transparent conductive film on the organic insulating film 13, metal film pieces ML serving as the film pieces on the ITO film 14, a SiN film 15 disposed on the ITO film 14 and the metal film pieces ML and covering the metal film pieces ML, and pixel electrodes 16 on the SiN film 15. The ITO film 14 and the SiN film 15 are disposed in a planar pattern in substantially the entire part of the display region (array region) excluding contact holes for coupling of the pixel electrodes 16 with the corresponding drain electrodes of the TFTs. The ITO film 14 serves as a common electrode (counter electrode). The metal film pieces ML are apart from each other and arranged in a dashed line pattern.

Each metal film piece ML may have a thickness of 10 nm to 400 nm (preferably 50 nm to 200 nm), for example.

The counter substrate 20 includes an insulating substrate 21, a color filter layer 22 on the insulating substrate 21, and a resin black matrix layer BM serving as a light-shielding member Q.

The array substrate 10 and the counter substrate 20 are each provided with an alignment film (not illustrated in FIGS. 2 and 3) on the surface close to the liquid crystal layer 30. The array substrate 10 and the counter substrate 20 are each provided with a polarizer (not illustrated) on the surface remote from the liquid crystal layer 30.

FIG. 4 is an exemplary schematic cross-sectional view of a region around a TFT of an array substrate in the liquid crystal display device of Embodiment 1. As illustrated in FIG. 4, the array substrate 10 includes TFTs 50, and also Includes the insulating substrate 11, a light-shielding film 41, a base coat film 42, a gate insulating film 43, the interlayer Insulating film 12, the organic insulating film 13, the ITO film 14, the metal film pieces ML, the SiN film 15, the pixel electrodes 16, and an alignment film 44 in the give order. The TFTs 50 each include a gate electrode 51 coupled with a gate line GL, a source electrode 52 coupled with a source line SL, a drain electrode 53 coupled with a pixel electrode 16, and a thin film semiconductor 54 formed from polysilicon. As illustrated in FIG. 4, the metal film pieces ML may be on the source electrode 52.

The array substrate 10 further includes a source driver (not illustrated) electrically coupled with the source lines SL and a gate driver (not illustrated) electrically coupled with the gate lines GL. The gate driver successively emits a scanning signal to a gate line GL based on the control by a controller (not illustrated). The source driver emits a data signal to a source line SL based on the control by the controller at the timing when the corresponding TFT is turned into a voltage-applied state by a scanning signal. Each pixel electrode 16 is set to a potential corresponding to a data signal supplied through the corresponding TFT. A fringe electric field is then generated between the pixel electrode 16 provided with slits and the ITO film 14 that is a planar common electrode disposed with the SiN film 15 (pixel insulating film) disposed below the pixel electrode 16, rotating liquid crystal molecules in the liquid crystal layer 30. The magnitude of the voltage applied between the pixel electrode 16 and the common electrode is thereby controlled to vary the retardation of the liquid crystal layer 30, switching transmission and non-transmission of light.

As illustrated in FIGS. 1 to 3, the presence of the metal film pieces ML on the ITO film 14 and the presence of the SiN film 15 thereon lead to an anchoring effect, minimizing peeling. The metal film pieces ML on the lower gate lines GL can minimize a reduction in transmittance of the pixels. The dashed line pattern of the metal film pieces ML can increase the contact area of tapered portions of the metal film pieces ML and the SiN film 15, improving the anchoring effect.

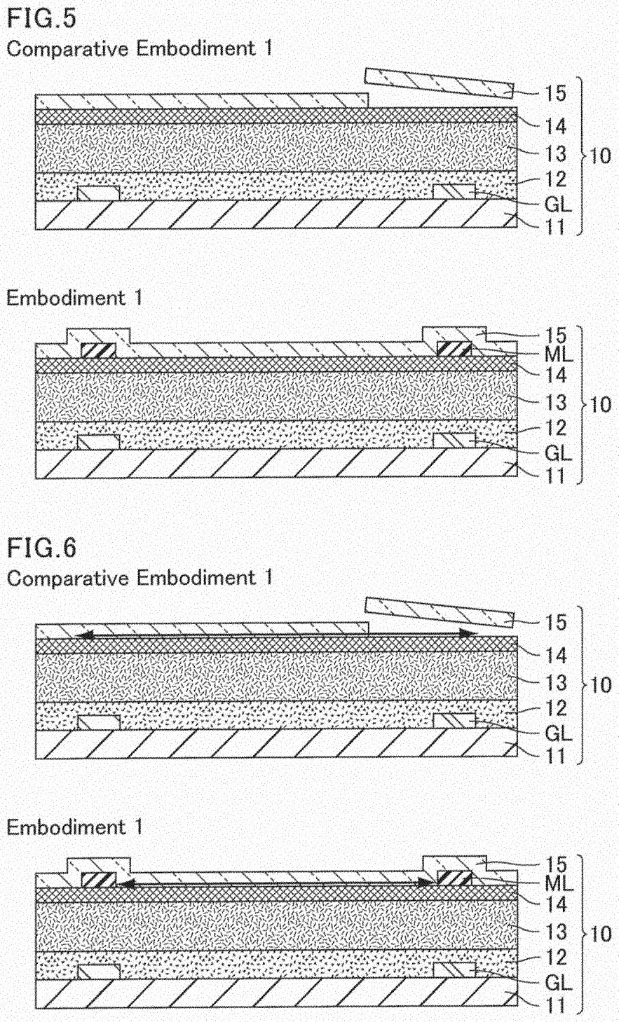

FIG. 5 includes schematic cross-sectional views for comparison of the liquid crystal display device of Embodiment 1 and a liquid crystal display device of Comparative Embodiment 1. In FIG. 5, the counter substrate 20 and the liquid crystal layer 30 are not illustrated. A liquid crystal display device of Comparative Embodiment 1 is similar to the liquid crystal display device of Embodiment 1, except that no metal film piece ML is present on the ITO film 14. As illustrated in FIG. 5, the presence of the metal film pieces ML on the ITO film 14 can reduce the contact area between the ITO film 14 and the SiN film 15, and the SiN film 15 covering the metal film pieces ML can generate an anchoring effect, reducing film peeling. The presence of the metal film pieces ML patterned along the gate lines GL, which are lower lines, can improve the adhesion without reducing the transmittance of the pixels.

FIG. 6 includes schematic cross-sectional views for comparison of the liquid crystal display device of Embodiment 1 and the liquid crystal display device of Comparative Embodiment 1. In FIG. 6, the counter substrate 20 and the liquid crystal layer 30 are not illustrated. As illustrated in FIG. 6, in the present embodiment, the contact area between the SiN film 15 and the ITO film 14 is smaller than in the liquid crystal display device of Comparative Embodiment 1, which can reduce the area with weaker adhesion. Further, the SiN film 15 covers the metal film pieces ML, and thus is expected to generate an anchoring effect.

### Embodiment 2

In the present embodiment, features unique to the present embodiment are mainly described and the same features as those of the above embodiment are not described. In Embodiment 1, the metal film pieces are at positions overlapping the gate lines. In the present embodiment, the metal film pieces are at positions overlapping the source lines.

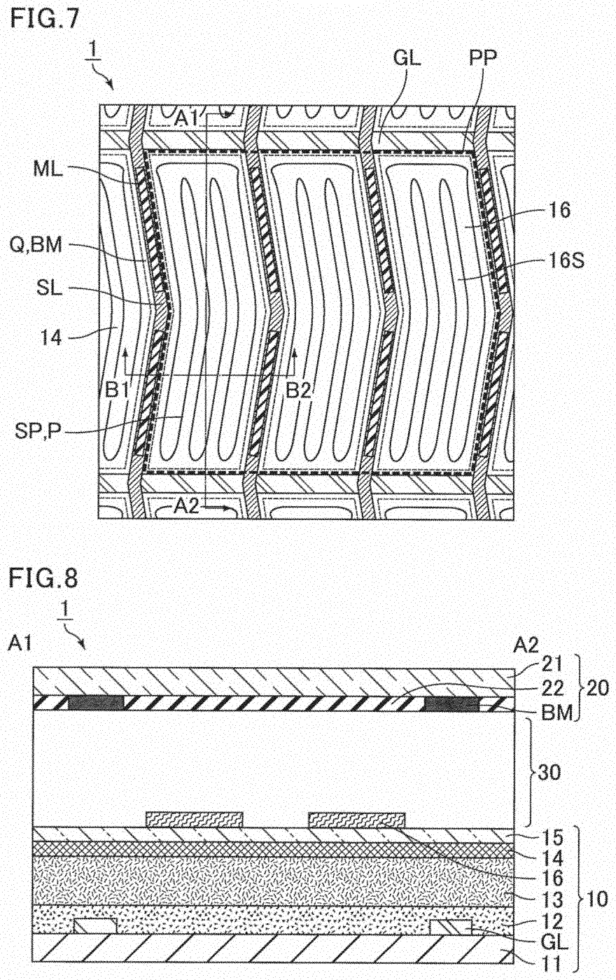

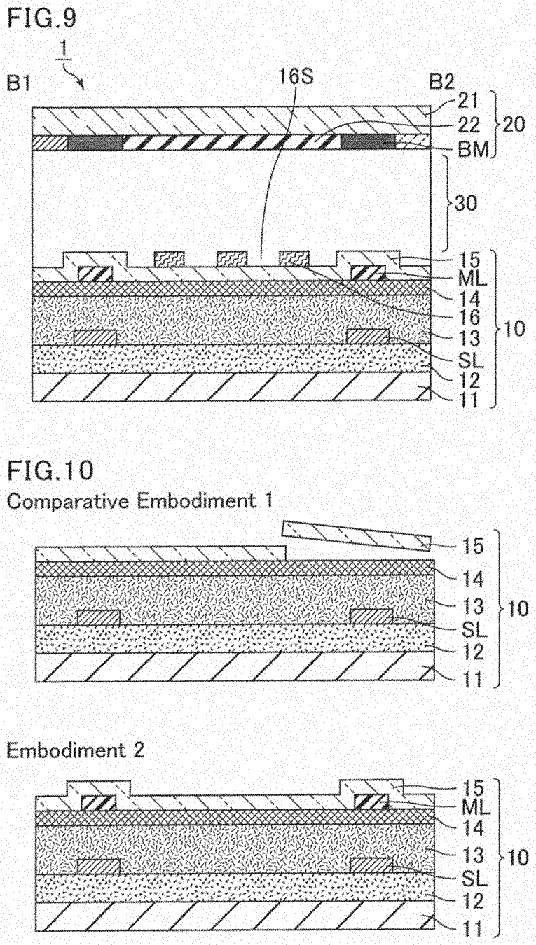

FIG. 7 is a schematic plan view of a liquid crystal display device of Embodiment 2, illustrating the structure of subpixels. FIG. 8 is a schematic cross-sectional view of the liquid crystal display device of Embodiment 2, illustrating the cross section taken along the A1-A2 line in FIG. 7. FIG. 9 is a schematic cross-sectional view of the liquid crystal display device of Embodiment 2, illustrating the cross section taken along the B1-B2 line in FIG. 7.

As illustrated in FIGS. 7 to 9, the presence of the metal film pieces ML on the ITO film 14 and the presence of the SiN film 15 thereon lead to an anchoring effect, minimizing peeling. The metal film pieces ML on the lower source lines SL can minimize a reduction in transmittance of the pixels. The dashed line pattern of the metal film pieces ML can increase the contact area with tapered portions, improving the anchoring effect.

FIG. 10 includes schematic cross-sectional views for comparison of the liquid crystal display device of Embodiment 2 and the liquid crystal display device of Comparative Embodiment 1. In FIG. 10, the counter substrate 20 and the liquid crystal layer 30 are not illustrated. The liquid crystal display device of Comparative Embodiment 1 is similar to the liquid crystal display device of Embodiment 2, except that no metal film piece ML is present on the ITO film 14. As illustrated in FIG. 10, the presence of the metal film pieces ML on the ITO film 14 can reduce the contact area between the ITO film 14 and the SiN film 15, and the SiN film 15 covering the metal film pieces ML can generate an anchoring effect, reducing film peeling. The presence of the metal film pieces ML patterned along the source lines SL, which are lower lines, can improve the adhesion without reducing the transmittance of the pixels.

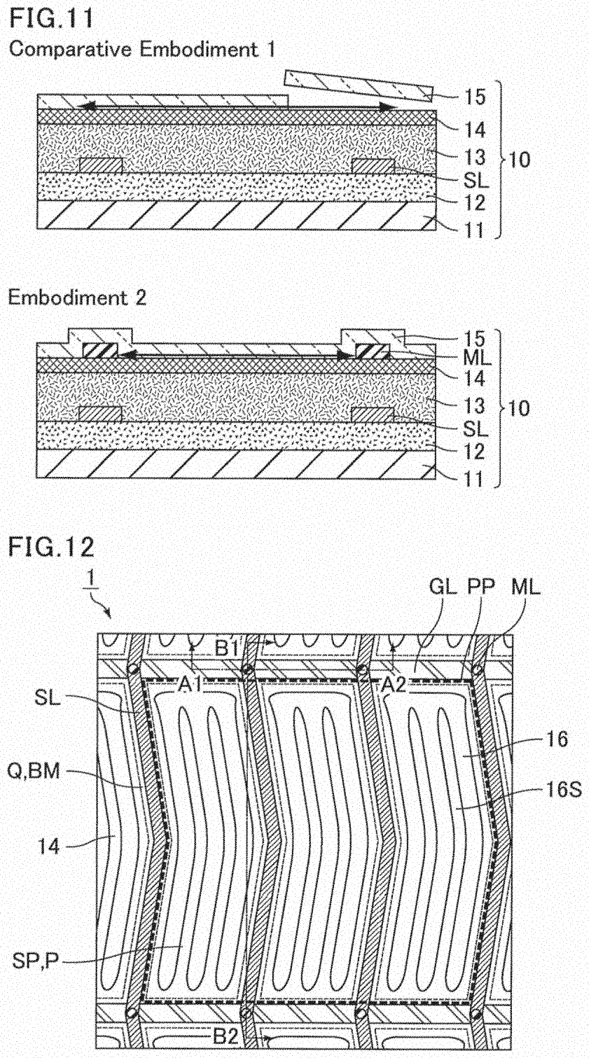

FIG. 11 includes schematic cross-sectional views for comparison of the liquid crystal display device of Embodiment 2 and the liquid crystal display device of Comparative Embodiment 1. In FIG. 11, the counter substrate 20 and the liquid crystal layer 30 are not illustrated. As illustrated in FIG. 11, in the present embodiment, the contact area between the SiN film 15 and the ITO film 14 is smaller than in the liquid crystal display device of Comparative Embodiment 1, which can reduce the area with weaker adhesion. The smaller the contact area with the ITO film 14 is, the better the effect of reducing film peeling is expected to be. Further, the SiN film 15 covers the metal film pieces ML, and thus is expected to generate an anchoring effect.

### Embodiment 3

In the present embodiment, features unique to the present embodiment are mainly described and the same features as those of the above embodiment are not described. In Embodiments 1 and 2, the metal film pieces are arranged in a dashed line pattern. In the present embodiment, the metal film pieces are arranged in an island pattern.

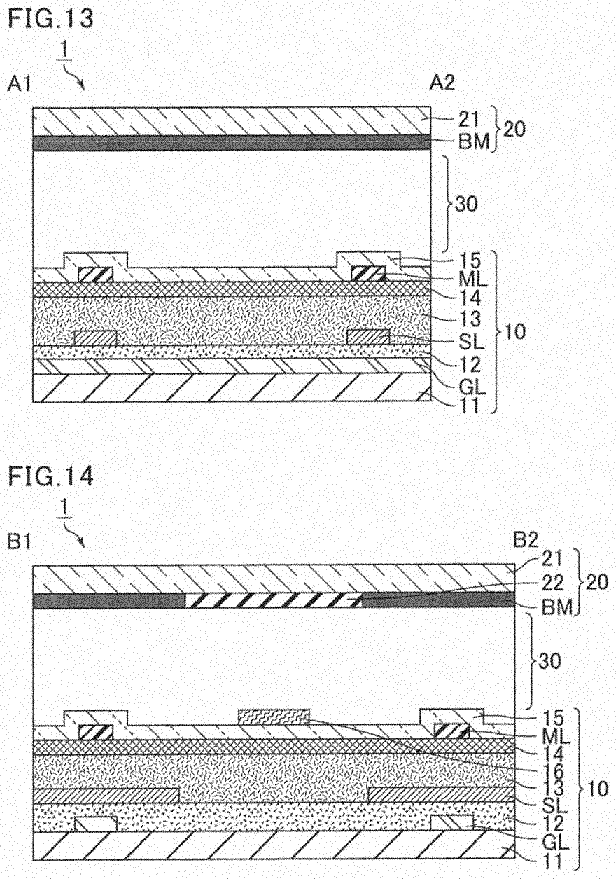

FIG. 12 is a schematic plan view of a liquid crystal display device of Embodiment 3, illustrating the structure of subpixels. FIG. 13 is a schematic cross-sectional view of the liquid crystal display device of Embodiment 3, illustrating the cross section taken along the A1-A2 line in FIG. 12. FIG. 14 is a schematic cross-sectional view of the liquid crystal display device of Embodiment 3, illustrating the cross section taken along the B1-B2 line in FIG. 12.

As illustrated in FIGS. 12 to 14, the presence of the metal film pieces ML on the ITO film 14 and the presence of the SiN film 15 thereon lead to an anchoring effect, minimize peeling. The metal film pieces ML arranged in a regular island pattern ensure the contact area of the SiN film 15 and tapered portions of the metal film pieces ML.

The metal film pieces ML arranged in an island pattern can prevent a wide contact region between the SiN film 15 and the ITO film 14 with poor adhesion and generates an anchoring effect with the metal film pieces ML, reducing film peeling.

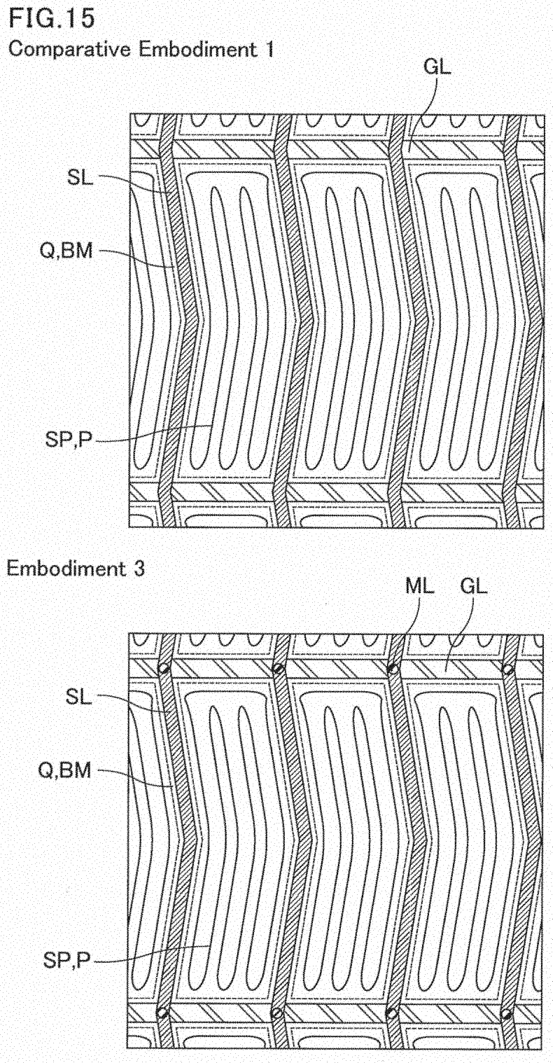

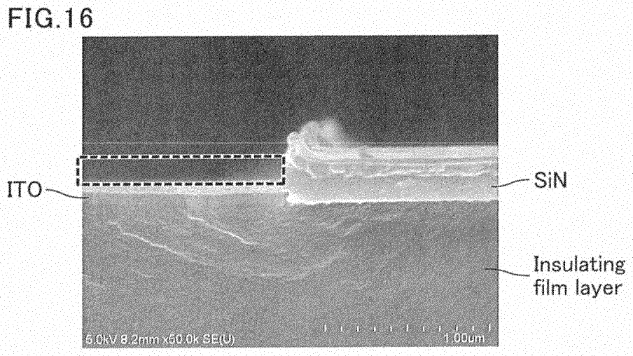

FIG. 15 includes schematic cross-sectional views for comparison of the liquid crystal display device of Embodiment 3 and the liquid crystal display device of Comparative Embodiment 1. The liquid crystal display device of Comparative Embodiment 1 is similar to the liquid crystal display device of Embodiment 3, except that no metal film piece ML is present on the ITO film 14. As illustrated in FIG. 15, the metal film pieces ML arranged in an island pattern also ensure the contact area of tapered portions of the metal film pieces ML and the SiN film 15 and can generate an anchoring effect, reducing film peeling. The metal film pieces ML arranged in an island pattern can minimize the area of the metal film pieces ML, reducing a decrease in transmittance due to factors such as exposure of the metal film pieces ML from the resin black matrix layer BM.

What is claimed is:

1. An array substrate for a liquid crystal display device, the array substrate comprising:
a transparent conductive film;
film pieces on the transparent conductive film; and
a silicon nitride film disposed on the transparent conductive film and the film pieces and covering the film pieces,
the film pieces being apart from each other.

2. The array substrate for a liquid crystal display device according to claim 1,
wherein the film pieces are arranged in a dashed line pattern.

3. The array substrate for a liquid crystal display device according to claim 1,
wherein the film pieces are arranged in an island pattern.

4. The array substrate for a liquid crystal display device according to claim 1, further comprising:
a thin film transistor;
a source line coupled with the thin film transistor; and
a gate line coupled with the thin film transistor and crossing the source line,
wherein, in a plan view, the film pieces are each in a region where at least one of the source line or the gate line is disposed.

5. A liquid crystal display device comprising the array substrate for a liquid crystal display device according to claim 1.

6. The liquid crystal display device according to claim 5, further comprising:
a counter substrate facing the array substrate for a liquid crystal display device; and
pixels arranged in a matrix pattern,
wherein the counter substrate includes a light-shielding member between adjacent pixels, and
in a plan view, the film pieces are each in a region where the light-shielding member is disposed.
